(19) United States
(12) Patent Application Publication
(10) Pub. No.: US 2008/0117024 A1
(43) Pub. Date: May 22, 2008

(54) METHOD FOR MANUFACTURE OF AN RFID WRISTBAND

(75) Inventor: Robert R. Oberle, Macungie, PA (US)

Correspondence Address: FLIESLER MEYER LLP, 650 CALIFORNIA STREET, 14TH FLOOR, SAN FRANCISCO, CA, 94108, US

(73) Assignee: RCD TECHNOLOGY INC., Quakertown, PA (US)

(21) Appl. No.: 11/853,687

(22) Filed: Sep. 11, 2007

Related U.S. Application Data
(60) Provisional application No. 60/866,167, filed on Nov. 16, 2006.

(51) Int. Cl. H04B 7/00; B29C 41/20

(52) U.S. Cl. 340/10.1; 156/227

(57) ABSTRACT

An RFID device can comprise a flexible substrate and an RFID tag formed on the flexible substrate. The flexible substrate can be folded over to encapsulate and protect the RFID tag.

### CLAIM OF PRIORITY

This application claims priority to U.S. Provisional Application No. 60/866,167 entitled “Method for Manufacture of an RFID Wristband” filed Nov. 16, 2006, which is incorporated herein by reference. [Atty. Docket No. RCDT-01012US0]

### SUMMARY OF INVENTION

The current method for manufacture of an RFID wristband can involve the lamination of one polymeric layer to another in a roll to roll process. This typically involves providing one film and laminating it to another film. Either film may have an RFID device fabricated on them or the RFID device may be on a third lamella inserted between two other lamellas.

### BRIEF DESCRIPTION OF THE DRAWINGS

FIG. 1 shows a cross-sectional view of a RFID device of one embodiment.

FIG. 2 shows a top view of an RFID device before folding a flexible substrate.

FIG. 3 shows a top view of an RFID device of another embodiment before folding a flexible substrate.

FIG. 4 shows a cross-sectional view of an RFID device of an additional embodiment.

### DETAILED DESCRIPTION

Among the shortcomings of the known methods is the limited ability to align portions of the final circuit with other portions of the device. The other portions may be constituent portions of the RFID circuitry that are fabricated on different lamellae or graphics which are required to maintain registry with the circuitry. The failure to maintain registry may result in poor yield, or substandard product. A difficulty can arise from the fact that each lamella is individually produced on some form of continuous web and even a small deviation in the process registry from one lamella to another will progressively worsen as a continuous roll of material is processed. This difficulty is even more apparent with the registration of electronic components on separate constituent lamellae as their relative positions in the final product may be critical to the performance of the final device. This alignment of electronic components in the final RFID circuit can be critical to both functionality and final product appearance.

The registration of two components in the flexible circuit such as an RFID wristband may be critical to the performance of the device. For example, if conductive layer of a thin film capacitor is laminated out of registry with the other conductive layer, the capacitance of the device will be incorrect which will cause a performance degradation of the entire circuit. In some embodiments of the present invention, this problem may be avoided.

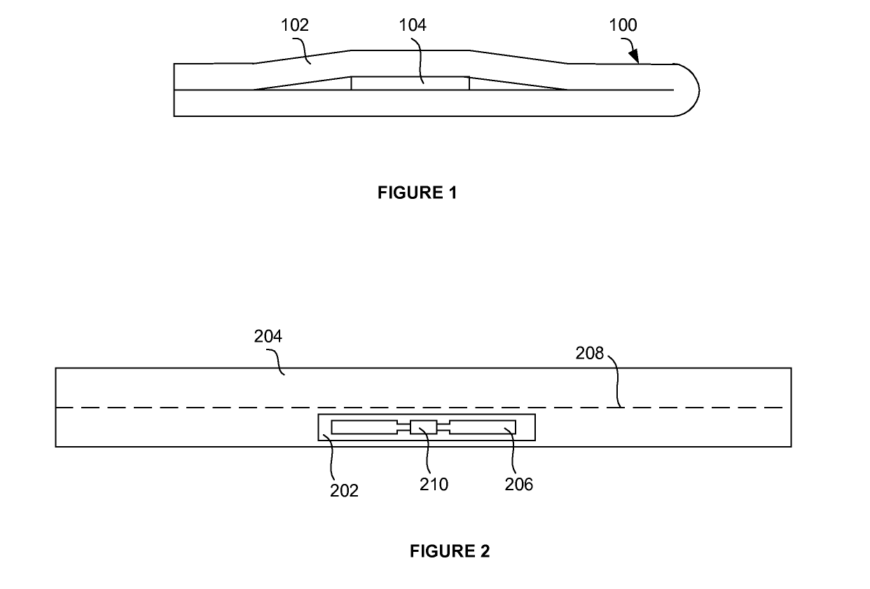

FIG. 1 shows a cross-section of an RFID device 100 with a flexible substrate 102. An RFID tag 104 can be formed on the flexible substrate 102. The flexible substrate 102 can be folded over to encapsulate and protect the RFID tag 104. This can avoid the registration problem and can simplify manufacture.

RFID device can be a RFID wristband for use identifying a person. A connector can be formed on the RFID wristband. The connector can be any type of connector to clasp the RFID wristband together.

As shown in FIG. 2, the RFID tag 202 can include an RFID chip 210 and an RFID antenna 206. The RFID antenna 206 can be formed with a conductive ink layer. A metal layer can be electroplated on top of the conductive ink layer in the shape of the antenna.

The substrate 204 can have a fold line 208. The fold line 208 may be incorporated into the circuit image simultaneously with the circuit itself.

The flexible substrate 204 can be a laminate material such as a plastic. The flexible substrate 204 can encapsulate the RFID tag with pressure or by using glue or another type of adhesive.

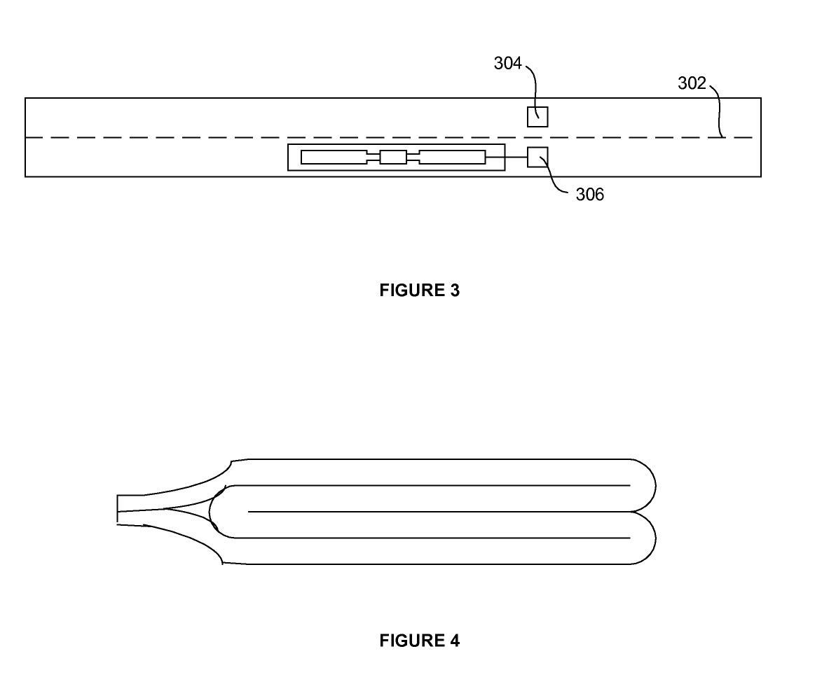

FIG. 3 shows an example where an element of the RFID circuit is created by the folding. In this example, a capacitor can be constructed by the folding along line 302. After folding, plate 304 is positioned above plate 306. The adhesive layer can act as a dielectric layer of the capacitor. Other arrangements can also be done.

Additionally a multifold system can be used. The multifold system shown in FIG. 4 can be used to stack RFID antenna elements over each other.

Exemplary methods can insure that the circuit elements are placed in register and have the advantage that in a continuous web fabrication process is very robust relative to variations in the circuit formation process.

It is not necessary that the method is limited to the registration of conductive elements; any imaged feature whether part of an electron circuit, visual graphic, or other functional mark that should be in register with other components of the device may be incorporated into the production process.

Further the folded and secured web may be cut to a desired shape in the later manufacturing step by traditional die-cutting equipment, with the requisite fiducials required to insure that the mechanical cutting operation does not destroy the circuit incorporated in the original imagining process.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed is:

1. An RFID device comprising:
a flexible substrate; and
an RFID tag formed on the flexible substrate, wherein the flexible substrate is folded over to encapsulate and protect the RFID tag.

2. The RFID device of claim 1, wherein the RFID device is a RFID wristband.

3. The RFID device of claim 2, further comprising a connector on the RFID wristband.

4. The RFID device of claim 1, wherein the RFID tag includes an RFID antenna.

5. The RFID device of claim 4, wherein the RFID antenna has a conductive ink layer.

6. The RFID device of claims 1, wherein the substrate has a fold line.

7. The RFID device of claim 1, wherein the RFID tag includes an RFID chip.

8. The RFID device of claim 1, wherein the flexible substrate encapsulates the RFID tag under pressure.

9. The RFID device of claim 1, wherein the flexible substrate encapsulates the RFID tag using glue.

10. A method of forming an RFID tag comprising:
forming an RFID tag on a flexible substrate; and
folding the flexible substrate to encapsulate and protect the RFID tag.

11. The RFID method of claim 10, wherein the RFID device is a RFID wristband.

12. The RFID method of claim 11, further comprising a connector on the RFID wristband.

13. The RFID method of claim 10, wherein the RFID tag includes an RFID antenna.

14. The RFID method of claim 13, wherein the RFID antenna is folded along a conductive ink layer.

15. The RFID method of claim 10, wherein the flexible substrate has a fold line.

16. The RFID method of claim 10, wherein the RFID tag includes an RFID chip.

17. The RFID method of claim 10, wherein the flexible substrate encapsulates the RFID tag under pressure.

18. The RFID method of claim 10, wherein the flexible substrate encapsulates the RFID tag using glue.

19. An RFID device comprising:
a flexible substrate; and
an RFID tag formed on the flexible substrate, wherein the flexible substrate is folded over to encapsulate and protect the RFID tag and wherein an element of the RFID tag is created by the folding of the flexible substrate.

20. The RFID device of claim 19, wherein the element is a capacitor.
